(19) United States
(12) Patent Application Publication
(10) Pub. No.: US 2001/0005473 A1
(43) Pub. Date: Jun. 28, 2001

(54) Structure and method of bonding parts

(76) Inventors: Takeji Shiokawa, Tsukui-gun (JP); Mitsuya Mikawa, Isehara (JP); Hideo Kaminaga, Hitachinaka (JP)

Correspondence Address: BEALL LAW OFFICES, 104 East Hume Avenue, Alexandria, VA, 22301, US

(21) Appl. No.: 09/764,405

(22) Filed: Jan. 19, 2001

Related U.S. Application Data
(63) Continuation-in-part of application No. 08/803,232, filed on Feb. 20, 1997.

(30) Foreign Application Priority Data
Mar. 2, 2000 (JP) 2000-057203

(51) Int. Cl. F16B 21/00

(52) U.S. Cl. 411/339

(57) ABSTRACT

A tapered barrel with a female thread is embedded in a tapered hole of a first soft member. A tapered barrel with a throughhole is embedded in a tapered hole of a second soft member. A bolt is inserted through the throughhole and screwed into the female thread. The tapered hole has a tapered portion, the height of which is substantially equal to the length of a tapered portion of the tapered barrel.

This is a Continuation-in-part application of U.S. Ser. No. 08/803,232 filed on Feb. 20, 1997.

### BACKGROUND OF THE INVENTION

1. Technical Field of the Invention

The present invention relates to a structure and method of bonding parts, and more particularly, to a structure and method of coupling members which are suitable for coupling soft members or brittle members together or for coupling a soft member or a brittle member with another member.

2. Description of the Related Art

Conventionally, when two members are coupled, a bolt and a nut are used for fastening the two members by screwing the bolt into the nut in a variety of applications. In this event, when at least one of two members to be coupled is a brittle member made of cement, ceramic, stone material, glass or the like, or when at least one of two members to be coupled is a soft member made of plastic, wood or the like, a coupling method using a bolt and a nut is still used. For a soft member, it is also known to mold a plastic material into the soft member integrally with a nut and so on.

However, for fastening a brittle member and another member together (including the fastening of brittle members together) using a screw, an excessively large fastening force would cause fracture of the brittle member. On the other hand, for fastening a soft member and another member together (including the fastening of soft members together) using a screw, an excessive fastening force would cause fracture or crushing of the soft member.

### OBJECT AND SUMMARY OF THE INVENTION

It is an object of the present invention to provide a structure and method of bonding parts which prevent fracture and so on even when a brittle member or a soft member is coupled to another member.

To achieve the above object, the present invention provides a structure of bonding parts which includes a first member formed with a first hole having a tapered portion, a second member formed with a second hole for inserting a screw thereinto, and a first tapered barrel embedded in the first hole and having a tapered portion, wherein the first and second members are fastened with a bolt inserted through the first and second holes arranged in alignment with each other, and the tapered portion of the first hole has a height substantially equal to the length of the tapered portion of the first tapered barrel.

Also, to achieve the above object, the present invention provides a method of bonding parts which includes the steps of forming a first member with a first hole having a tapered portion, embedding a first tapered barrel having a tapered portion into the first hole, forming a second member with a hole extending therethrough, arranging the first and second members such that the first hole is in alignment with the second hole, and fastening the first and second members together by inserting a bolt through the first second holes, wherein the tapered portion of the first hole has a height substantially equal to a length of the tapered portion of the first tapered barrel.

The structure and method described above allow a brittle member or a soft member to be coupled even with a member made of a different material without cracking and so on.

### BRIEF DESCRIPTION OF THE DRAWINGS

FIG. 1 is a partial cross-sectional view illustrating a first coupling structure in which two soft members are coupled together in an embodiment of the present invention;

FIG. 2 is a cross-sectional view illustrating the structure of a soft member for use in a first method of coupling soft members together in an embodiment of the present invention;

FIG. 3A is a cross-sectional view illustrating the structure of a tapered barrel with a throughhole for use in the first method of coupling soft members together in the embodiment of the present invention;

FIG. 3B is a cross-sectional view illustrating the structure of a tapered barrel with a female thread for use in the first method of coupling soft members together;

FIG. 4A is a cross-sectional view illustrating how a tapered barrel with a throughhole is embedded in a soft member in the first coupling structure in which two soft members are coupled together in the embodiment of the present invention;

FIG. 4B is a cross-sectional view illustrating how a tapered barrel with a female thread is embedded in a soft member in the first coupling structure;

FIG. 5 is a partial cross-sectional view illustrating a second coupling structure in which two soft members are coupled together in an embodiment of the present invention;

FIG. 6 is a cross-sectional view illustrating the structure of a soft member for use in a second method of coupling soft members together in an embodiment of the present invention;

FIG. 7 is a cross-sectional view illustrating how a tapered barrel is embedded in a soft member in the second coupling structure in which two soft members are coupled together in the embodiment of the present invention;

FIG. 8 is a partial cross-sectional view illustrating a third coupling structure in which two soft members are coupled together in an embodiment of the present invention;

FIG. 9 is a front view of a tapered barrel with a stud bolt for use in the third coupling structure in which two soft members are coupled together in the embodiment of the present invention;

FIG. 10 is a partial cross-sectional view illustrating a fourth coupling structure in which two soft members are coupled together in an embodiment of the present invention;

FIG. 11 is a partial cross-sectional view illustrating a first coupling structure in which a soft member and a metal member are coupled together in an embodiment of the present invention;

FIG. 12 is a partial cross-sectional view illustrating a second coupling structure in which a soft member and a metal member are coupled together in an embodiment of the present invention;

FIG. 13 is a partial cross-sectional view illustrating a third coupling structure in which a soft member and a metal member are coupled in an embodiment of the present invention;

FIG. 14 is a partial cross-sectional view illustrating a first coupling structure in which two brittle members are coupled together in an embodiment of the present invention;

FIG. 15 is a partial cross-sectional view illustrating a second coupling structure in which two brittle members are coupled together in an embodiment of the present invention;

FIG. 16 is a partial cross-sectional view illustrating a third coupling structure in which two brittle members are coupled together in an embodiment of the present invention;

FIG. 17 is a partial cross-sectional view illustrating a first coupling structure in which a brittle member and a metal member are coupled together in an embodiment of the present invention;

FIG. 18 is a partial cross-sectional view illustrating a second coupling structure in which a brittle member and a metal member are coupled together in an embodiment of the present invention;

FIG. 19 is a partial cross-sectional view illustrating a coupling structure in which a brittle member and a soft member are coupled together in an embodiment of the present invention;

FIG. 20 is a partial cross-sectional view illustrating a coupling structure in which three soft members are coupled together in an embodiment of the present invention;

FIG. 21 is a partial cross-sectional view illustrating a first coupling structure in which two soft members and a metal member are coupled together in an embodiment of the present invention; and

FIG. 22 is a partial cross-sectional view illustrating a second coupling structure in which two soft members and a metal member are coupled together in an embodiment of the present invention.

### DETAILED DESCRIPTION OF THE PREFERRED EMBODIMENTS

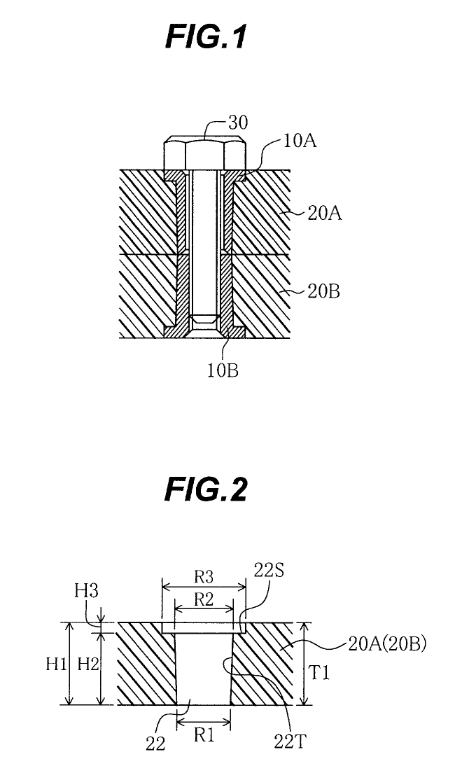

In the following, various coupling structure and methods of two soft members will be described with reference to FIGS. 1 through 10.

Referring first to FIG. 1, description will be made on a first coupling structure of two soft members according to an embodiment.

FIG. 1 is a partial cross-sectional view of a first coupling structure in which two soft members are coupled together in an embodiment of the present invention.

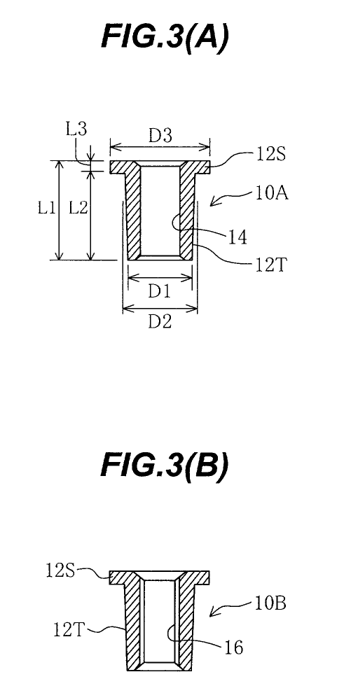

A tapered barrel 10A with a throughhole has been previously embedded in a soft member 20A made of plastic or the like. On the other hand, a tapered barrel 10B with a female thread has been previously embedded in a soft member 20B made of plastic or the like. The tapered barrels 10A, 10B are formed of a material harder than the soft members 20A, 20B such as stainless steel, iron, brass, aluminum, hard resin or the like. Among these materials, stainless steel, iron and brass, which are relatively hard materials, are particularly suitable for protecting the soft members 20A, 20B from crushing or fracture when they are fastened together with a bolt. Detailed structures of the tapered barrels 10A, 10B will be described later with reference to FIG. 3. The soft member 20A having the tapered barrel 10A embedded therein is placed on the soft member 20B having the tapered barrel 10B embedded therein with the tapered barrels 10A, 10B aligned with each other, and a bolt 30 is inserted through the central throughhole of the tapered barrel 10A, so that a male thread formed on the bolt 30 is engaged with the female thread of the tapered barrel 10B to couple the soft members 20A, 20B together.

With such a coupling structure, a fastening force exerted by the bolt 30 or the like acts on the tapered barrels 10A, 10B even when the soft members made of a resin material or the like are fastened together, thereby making it possible to protect the soft members from cracking (creep) and so on.

Next, a method of coupling soft members together in accordance with an embodiment will be described with reference to FIGS. 2 through 4.

Referring first to FIG. 2, the structure of a soft member will be described for use in the method of coupling soft members together in accordance with an embodiment.

FIG. 2 is a cross-sectional view illustrating the structure of a soft member for use in a first method of coupling soft members together in an embodiment of the present invention. The same reference numerals as those in FIG. 1 designate the same parts.

Since the soft member 20A is identical in structure to the soft member 20B, the soft member 20A is described here as an example.

The soft member 20A is previously formed with a tapered hole 22. When the soft member 20A is a molding made of resin or the like, the tapered hole 22 may be formed by integral molding when the soft member 20A is molded using a mold having a portion corresponding to the tapered hole 22. Alternatively, the tapered hole 22 may be formed by machining or the like.

The tapered hole 22 is comprised of a tapered portion 22T and a step portion 22S. The tapered portion 22T is formed such that R2>R1 stands, where R1 is the diameter of a reduced end, and R2 is the diameter of an enlarged end at which the step portion 22S is formed. The tapered portion 22T is tapered, for example, at a rate of 1/20. The step portion 22S is formed at the enlarged end of the taper portion 22T. The step portion 22T has a diameter R3 which satisfies R3>R2. The step portion 22T protrudes in a direction orthogonal to the direction of the center axis of the taper portion 22T.

Specific examples are given below. In a first example, when the diameter R1 of the reduced end is 8.7 mmφ, the diameter R2 of the enlarged end is 9.0 mmφ. The diameter R3 of the step portion 22S is 10.0 mmφ. As a second example, when the diameter R1 of the reduced end is 1.8 mmφ, the diameter R2 of the enlarged end is 2.0 mmφ. The diameter R3 of the step portion 22S is 2.6 mm.

Assuming that the tapered hole 22 has an overall height H1; the tapered portion 22T, H2; and the step portion 22S, H3, H1=H2+H3 stands. For example, in the foregoing first example, when the overall height H1 of the tapered hole 22 is 12 mm, the height H2 of the tapered portion 22T is 11 mm, and the thickness H3 of the step portion 22S is 1 mm. In the foregoing second example, when the overall height H1 of the tapered hole 22 is 2.2 mm, the height H2 of the tapered portion 22T is 2 mm, and the thickness H3 of the step portion 22S is 0.2 mm.

It should be noted that the thickness T1 of the soft member 20A and the overall height H1 of the tapered hole 22 may not necessarily satisfy the relationship H1=T1. Specifically, though depending on the material of the first member and the second member, the height H1 may fall within a range of 85% to 100% of the thickness T1. The height H1 does not exceed 100% of the thickness H1 because if the value of the height H1 is larger than the value of the thickness T1, the first member 20A and second member 20B cannot be fastened to each other. Even if the thickness H1 is smaller than the height H1, they are regarded as substantially equal as long as they are sufficient to fasten the first member 20A and second member 20B together.

In addition, the height H1 is not equal to or less than 85% of the thickness T1 because an excessive difference between H1 and T1 would require a screw to be strongly screwed up until the reduced end of the tapered portion 12T of the tapered barrel 10A comes in contact with the reduced end of the tapered portion 12T of the tapered barrel 10B in order to fasten the first member 20A and the second member 20B, thereby causing these members, which may be soft members or brittle members, to crack or crush. Therefore, while specific values depend on a particular combination of members, the members can be sufficiently fastened together even if a screw is screwed to such a degree as to prevent damages on the members due to the fastening, as long as the height H1 is limited to approximately 85% of the thickness T1.

Next, referring to FIG. FIGS. 3A and 3B, description will be made on the structure of the tapered barrels for use in the method of coupling soft members together according to this embodiment.

FIGS. 3A and 3B are cross-sectional views each illustrating the structure of the tapered barrel for use in the first method of coupling soft members together according to this embodiment. Specifically, FIG. 3A illustrates the structure of the tapered barrel 10A with a throughhole, and FIG. 3B illustrates the structure of the tapered barrel 10B with a female thread. The same reference numerals as those in FIGS. 1 and 2 designate the same parts.

As illustrated in FIG. 3A, the tapered barrel 10A with a throughhole is comprised of a tapered portion 12T and a collar portion 12S. The tapered portion 12T has a frustoconical outer surface. Assuming that one end of the tapered portion 12T has a D1, the other end, at which the collar portion 12S is formed, has a diameter D2 which satisfies D2>D1. The tapered portion 12T is tapered, for example, at a rate of 1/20. Giving a specific example, when the diameter D1 of the reduced end is 8.7 mmφ, the diameter D2 of the enlarged end, at which the collar portion 12S is formed, is 9.0 mmφ. The collar portion 12S is formed on the enlarged end of the tapered portion 12T, and is formed protrusively with respect to the tapered portion 12T. The collar portion 12S has a diameter D3 which satisfies D3>D2. The collar portion 12S protrudes in a direction orthogonal to the direction of the center axis of the tapered portion 12T. In the foregoing example, the diameter D3 of the collar portion 12S is 10.0 mmφ, by way of example. Also, when the tapered barrel 10 has an overall length L1, for example, equal to 12 mm, the tapered portion 12T has a length L2 equal to 11 mm, and the collar portion 12S has a thickness L3 equal to 1 mm. Further, the tapered barrel 10A is formed with a throughhole 14 extending therethrough.

Next, as illustrated in FIG. 3B, the tapered barrel 10B with a female thread is comprised of a tapered portion 12T and a collar portion 12S. The tapered barrel 10A is also formed therein with the female thread 16. The dimensions and shapes of the tapered portion 12T and the collar portion 12S of the tapered barrel 10B are similar to those of the tapered barrel 10A illustrated in FIG. 3A.

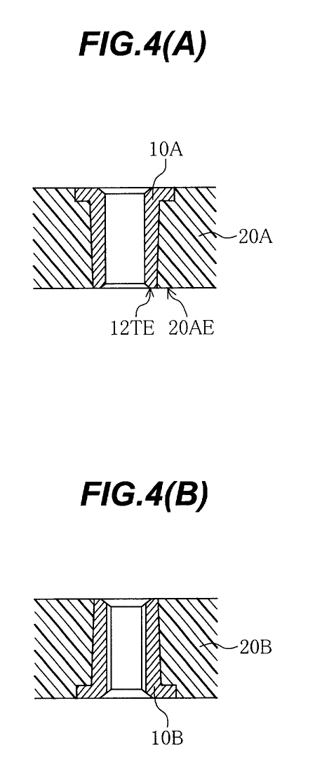

Next, referring to FIGS. 4A and 4B, description will be made on the structures in which the tapered barrels according to this embodiment are embedded in the aforementioned soft members.

FIGS. 4A and 4B are cross-sectional views each illustrating the structure in which a tapered barrel is embedded in a soft member in accordance with this embodiment. Specifically, FIG. 4A illustrates the structure in which the tapered barrel 10A with a throughhole is embedded in the soft member 20A, and FIG. 4B illustrates a structure in which the tapered barrel 10B with a female thread is embedded in the soft member 20B. The same reference numerals as those in FIGS. 1 through 3 designate the same parts.

As the reduced end of the tapered portion 12T of the tapered barrel 10A with a throughhole illustrated in FIG. 3A is dropped into the tapered hole 22 of the soft member 20A illustrated in FIG. 2, the end of the tapered portion 12T is slightly inserted into the tapered hole 22. Next, a force is applied with a hammer or the like from the collar portion 12S of the tapered barrel 10A to insert the tapered barrel 10A with a throughhole into the tapered hole 22 of the soft member 20A, as illustrated in FIG. 4A, with the result that the tapered portion of the tapered hole 22 engages with the tapered portion 12T of the tapered barrel 10A, so that the tapered barrel 10A is securely embedded into the soft member 20A.

In a similar manner, as the reduced end of the tapered portion 12T of the tapered barrel 10B with a female thread is dropped into the tapered hole 22 of the soft member 20B, which has a similar shape to that of the soft member 20A illustrated in FIG. 2, the end of the tapered portion 12T is slightly inserted into the tapered hole 22. Next, a force is applied with a hammer or the like from the collar portion 12S of the tapered barrel 10A to fit the tapered barrel 10B with a female thread into the tapered hole 22 of the soft member 20B, as illustrated in FIG. 4B, with the result that the tapered portion of the tapered hole 22 engages with the tapered portion 12T of the tapered barrel 10B, so that the tapered barrel 10B is securely embedded into the soft member 20B. In this way, the tapered hole 22 for inserting a bolt therethrough has its periphery surrounded by the tapered barrel 10B which is a hard member.

Next, the reduced end of the tapered barrel 10A of the soft member 20A illustrated in FIG. 4A is placed to face the reduced end of the tapered barrel 10B of the soft member 20B illustrated in FIG. 4B. In other words, the soft member 20B illustrated in FIG. 4B is turned upside down, and placed on the soft member 20A illustrated in FIG. 4A such that the tapered barrel 10A is in alignment with the tapered barrel 10B. Subsequently, the bolt 30 is inserted from the collar portion 12S of the tapered barrel 10A of the soft member 20A, such that the bolt 30 extends through the central throughhole of the tapered barrel 10A, to engage the male thread of the bolt 30 with the female thread 16 of the tapered barrel 10B. In this way, the soft members 20A, 20B are coupled together as illustrated in FIG. 1.

As described above, in this embodiment, the height H2 of the tapered portion 22T of the tapered hole 22 illustrated in FIG. 2 is equal to the length L2 of the tapered portion 12T of the tapered barrel 10A illustrated in FIG. 3. Therefore, in the state illustrated in FIG. 4, the end 12TE of the tapered portion 12T of the tapered barrel 10A is flush with the end face 12AE of the soft member 20A. In other words, the end 12TE of the tapered portion 12T does not protrude from the end face 12AE of the soft member 20A. Therefore, as illustrated in FIG. 1, when the bolt 30 is screwed into engagement with the female thread 16 of the tapered barrel 10B to fasten the soft members 20A, 20B together, the reduced end of the tapered barrel 10A is brought into contact with the reduced end of the tapered barrel 10B, and the two tapered barrels 10A, 10B are fastened together. Simultaneously, the opposing faces of the soft members 20A, 20B are also brought into contact with each other, and the soft members 20A, 20B are fastened together. In consequence, the two members 20A, 20B are securely coupled. Specifically, on the contact faces of the soft members 20A, 20B, the fastening force exerted by the bolt 30 is applied centered on the end faces of the tapered barrels 10A, 10B around the bolt 30 to securely couple the soft members 20A, 20B together.

Further preferably, for example, in the first specific example previously described in connection with FIG. 2, the length L2 of the tapered portion 12T of the tapered barrel 10A is made shorter than the height H2 (11 mm) of the tapered portion 22T of the tapered hole 22 by a range of 0.02 to 0.2 mm (H2=L2+0.02-0.2 mm). By thus defining the length L2, the reduced end of the tapered barrel 10A is not in contact with the reduced end of the tapered barrel 10B when the soft member 20A is brought into contact with the soft member 20B. However, by screwing the bolt 30 into engagement with the female thread 16 of the tapered barrel 10B to fasten the tapered barrels 10A, 10B together as illustrated in FIG. 1, the reduced end of the tapered barrel 10A is brought into contact with the reduced end of the tapered barrel 10B, and the two tapered barrels 10A, 10B are fastened together with the soft members 20A, 20B slightly compressed. As a result, the soft member 20A and the soft member 20B are firmly coupled together. The difference between the length L2 of the tapered portion 12T of the tapered barrel 10A and the height H2 of the tapered portion 22T of the tapered hole 22 (H2−L2) is preferably in a range of 0.02 to 0.2 mm in the aforementioned first specific example. If the difference exceeds this range, a larger compression force will act on the soft members 20A, 20B which are therefore susceptible to cracking or the like.

Stated another way, when the height H2 of the tapered portion 22T of the tapered hole 22 is made equal to the length L2 of the tapered portion 12T of the tapered barrel 10A illustrated in FIG. 3, or when the length L2 of the tapered portion 12T of the tapered barrel 10A is made shorter than the height H2 of the tapered portion 22T of the tapered hole 22 by a length ranging from 0.02 to 0.2 mm, the height H2 of the tapered portion 22T of the tapered hole 22 is made substantially equal to the length L2 of the tapered portion 12T of the tapered barrel 10A illustrated in FIG. 3. With the dimensions thus determined, the soft members 20A, 20B can be firmly coupled together and protected from cracking and so on.

Also, in this embodiment, the tapered barrels 10A, 10B are formed of a material harder than the soft members 20A, 20B, such as stainless steel, iron, brass, aluminum, hard resin or the like. Among these materials, stainless steel, iron and brass, which are relatively hard materials, may be preferably used. The employment of one of these materials makes the tapered barrels 10A, 10B less susceptible to deformation even if the bolt 30 is screwed into engagement with the female thread 16 of the tapered barrel 10B, as illustrated in FIG. 1, and therefore prevents the fastening force exerted by the bolt 30 from extending to the soft members 20A, 20B, thereby making it possible to protect the soft members 20A, 20B from crushing, cracking and so on.

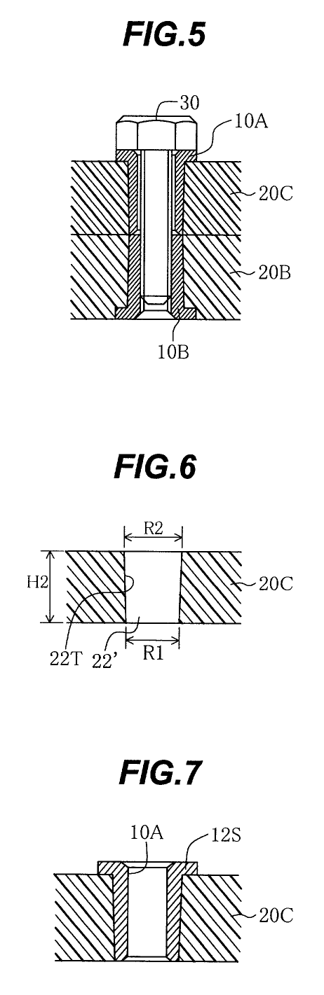

Next, a second coupling structure and method of two soft members according to an embodiment of the present invention, will be described with reference to FIGS. 5 through 7.

Referring first to FIG. 5, description will be made on the coupling structure of two soft members according to this embodiment.

FIG. 5 is a partial cross-sectional view illustrating a second coupling structure in which two soft members are coupled together in accordance with this embodiment. The same reference numerals as those in FIGS. 1 through 4 designate the same parts.

A tapered barrel 10A with a throughhole has been previously embedded in a soft member 20C made of plastic or the like. On the other hand, a tapered barrel 10B with a female thread has been previously embedded in a soft member 20B made of plastic or the like. The soft members 20C having the tapered barrel 10A embedded therein is placed on the soft member 20B having the tapered barrel 10B embedded therein with the tapered barrels 10A, 10B aligned to each other, and a bolt 30 is inserted through the central throughhole of the tapered barrel 10A such that a male thread of the bolt 30 is engaged with the female thread of the tapered barrel 10B, thereby coupling the soft members 20C, 20B together.

This embodiment differs from the aforementioned embodiment in the way the tapered barrel 10A is embedded in the soft member 20C, details of which will be described below with reference to FIGS. 6 and 7.

FIGS. 6 and 7 illustrate how the soft members are coupled together in accordance with this embodiment.

Description is first made on the structure of the soft member for use in a second method of coupling the soft members together according to this embodiment.

FIG. 6 is a cross-sectional view illustrating the structure of the soft member for use in the second method of coupling the soft members together according to the present invention. The same reference numerals as those in FIGS. 1 through 5 designate the same parts.

The soft member 20C has been previously formed with a tapered hole 22′. When the soft member 20C is a molding made of resin or the like, the tapered hole 22′ may be formed by integral molding when the soft member 20C is molded using a mold having a portion corresponding to the tapered hole 22′. Alternatively, the tapered hole 22′ may be formed by machining or the like.

The tapered hole 22′ comprises a tapered portion 22T. In other words, the step portion 22S in FIG. 2 is excluded from the tapered hole 22′ unlike the structure illustrated in FIG. 2. The tapered portion 22T is dimensioned such that R2>R1 stands, where R1 is the diameter of a reduced end of the tapered portion 22T, and R2 is the diameter of an enlarged end of the same. The tapered portion 22T is tapered, for example, at a rate of 1/20. Giving a specific example, when the diameter R1 of the reduced end is 8.7 mmφ, the diameter R2 of the enlarged end is 9.0 mmφ. Also, the tapered portion 22T has an overall height H2 equal to 11 mm, by way of example.

Referring next to FIG. 7, description will be made on the structure in which a tapered barrel is embedded in the soft member 20C in accordance with an embodiment.

FIG. 7 is a cross-sectional view illustrating a structure in which the tapered barrel 10A is embedded in the soft member 20C in accordance with this embodiment. The same reference numerals as those in FIGS. 1 through 6 designate the same parts.

The tapered barrel 10A with a throughhole has the structure as described with reference to FIG. 3. As the reduced end of the tapered portion 12T of the tapered barrel 10A with a throughhole is dropped into the tapered hole 22′ of the soft member 20C illustrated in FIG. 6, the end of the tapered portion 12T is slightly inserted into the tapered hole 22′. Next, a force is applied with a hammer or the like from the collar portion 12S of the tapered barrel 10A to insert the tapered barrel 10A with a throughhole into the tapered hole 22′ of the soft member 20C, as illustrated in FIG. 7. As a result, the tapered portion of the tapered hole 22′ engages with the tapered portion 12T of the tapered barrel 10A, the collar portion 12S stops at a position at which it comes in contact with an end face of the soft member 20C, and the tapered barrel 10A is securely embedded into the soft member 20C.

Next, after the reduced end of the tapered barrel 10A in the soft member 20C illustrated in FIG. 7 is arranged in alignment with the reduced end of the tapered barrel 10B of the soft member 20B illustrated in FIG. 4B, a bolt 30 is inserted from the collar portion 12S of the tapered barrel 10A in the soft member 20C such that the bolt 30 extends through the central throughhole of the tapered barrel 10A to engage the male thread of the bolt 30 with the female thread of the tapered barrel 10B, thereby coupling the soft members 20C, 20B together, as illustrated in FIG. 5.

Here, in this embodiment, the height H2 of the tapered portion 22T of the tapered hole 22′ illustrated in FIG. 6 is made equal to or shorter by a range of 0.02 to 0.2 mm than the length L2 of the tapered portion 12T of the tapered barrel 10A illustrated in FIG. 3 (H2=L2 +0.02-0.2 mm), thereby making it possible to firmly couple the soft members 20C, 20B together and to protect the soft members 20C, 20B from cracking and so on.

Also, in this embodiment, the tapered barrels 10A, 10B are formed of a material harder than the soft members 20C, 20B, such as stainless steel, iron, brass, aluminum, hard resin or the like, so that the fastening force exerted by the bolt 30 is less susceptible to extending to the soft members 20C, 20B, thereby making it possible to protect the soft members 20C, 20B from crushing, cracking and so on.

Further, as illustrated in FIG. 6, since the tapered hole 22′ formed through the soft member 20C only has the tapered portion 22T, the soft member 20C has a lower height (smaller thickness), so that a required height for the tapered portion 22T can be ensured even when the hole shape illustrated in FIG. 2 cannot sufficiently provide the height H2 of the tapered portion, thereby making it possible to firmly fasten the tapered barrel 10A to the tapered hole 22′.

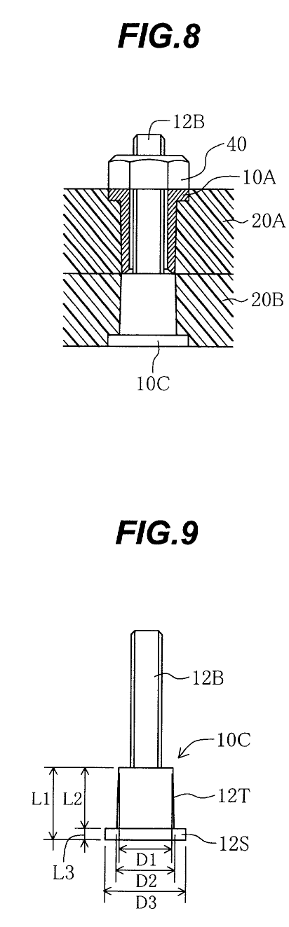

Referring next to FIGS. 8 and 9, description will be made on a third coupling structure and method of two soft members according to an embodiment.

First, the third coupling structure in which two soft members are coupled together in accordance to this embodiment will be described with reference to FIG. 8.

FIG. 8 is a partial cross-sectional view illustrating the third coupling structure in which two soft members are coupled together in accordance with this embodiment. The same reference numerals as those in FIGS. 1 through 7 designate the same parts.

A tapered barrel 10A with a throughhole has been previously embedded in a soft member 20A made of plastic or the like. On the other hand, a tapered barrel 10C with a stud bolt has been previously embedded in a soft member 20B made of plastic or the like. Detailed structures of the tapered barrel 10C with the stud bolt will be described later with reference to FIG. 9. The soft member 20A having the tapered barrel 10A embedded therein is placed on the soft member 20B having the tapered barrel 10C embedded therein, and the stud bolt 12B of the tapered barrel 10C is inserted through the central throughhole of the tapered barrel 10A and screwed into a nut 40 to couple the soft members 20A, 20B together.

The structures of the soft member 20A and the tapered barrel 10A with the throughhole, and the state in which the tapered barrel 10A is embedded in the soft member 20A are similar to those previously described in connection with FIGS. 2, 3A and 4A. Also, the shape of the soft member 20B is similar to that previously described in connection with FIG. 2.

In this embodiment, the tapered barrel 10C with the stud bolt 12B and the nut 40 are used to fasten the soft members 20A, 20B together, instead of the tapered barrel 10B with the female thread and the bolt 30 illustrated in FIG. 1. The structure of the tapered barrel 10C with the stud bolt 12B will be described below with reference to FIG. 9.

FIG. 9 is a front view of the tapered barrel 10C with the stud bolt 12B for use in this embodiment. The same reference numerals as those in FIGS. 1 through 8 designate the same parts.

The tapered barrel 10C with the stud bolt 12B is comprised of a tapered portion 12T, a collar portion 12S and the stud bolt 12B. The tapered portion 12T has a frustoconical outer surface. Assuming that a reduced end of the tapered portion 12T is D1, the other enlarged end, at which the collar portion 12S is formed, has a diameter D2 which satisfies D2>D1. The tapered portion 12T is tapered, for example, at a rate of 1/20. Giving a specific example, when the diameter D1 of the reduced end is 8.7 mmφ, the diameter D2 of the enlarged end, at which the collar portion 12S is formed, is 9.0 mmφ. The collar portion 12S is formed on the enlarged end of the tapered portion 12T, and protrudes from the tapered portion 12T. The collar portion 12S has a diameter D3 which satisfies D3>D2. The collar portion 12S protrudes in a direction orthogonal to the direction of the center axis of the tapered portion 12T. In the foregoing example, the diameter D3 of the collar portion 12S is 10.0 mmφ, by way of example. Also, when the tapered barrel 10 has an overall length L1, for example, equal to 12 mm, the tapered portion 12T has a length L2 equal to 11 mm, and the collar portion 12S has a thickness L3 equal to 1 mm. Further, the tapered barrel 10A is formed with a throughhole 14 extending therethrough. The stud bolt 12B is implanted on the reduced end of the tapered portion 12T.

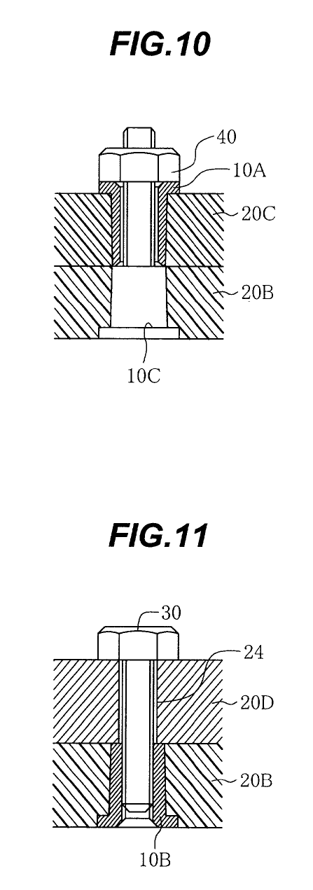

Referring next to FIG. 10, description will be made on a fourth coupling structure and method of two soft members according to an embodiment.

FIG. 10 is a partial cross-sectional view illustrating the fourth coupling structure in which two soft members are coupled together in accordance with this embodiment. The same reference numerals as those in FIGS. 1 through 9 designate the same parts.

A tapered barrel 10A with a throughhole has been previously embedded in a soft member 20C made of plastic or the like. On the other hand, a tapered barrel 10C with a stud bolt has been previously embedded in a soft member 20B made of plastic or the like. The detailed structure of the tapered barrel 10C with the stud bolt will be described later with reference to FIG. 9. The soft member 20C having the tapered barrel 10A embedded therein is placed on the soft member 20B having the tapered barrel 10C embedded therein, and the stud bolt 12B of the tapered barrel 10C is inserted through the central throughhole of the tapered barrel 10A and screwed into a nut 40 to couple the soft members 20C, 20B together.

The structures of the soft member 20C and the tapered barrel 10A with the throughhole, and the state in which the tapered barrel 10A is embedded in the soft member 20C are similar to those previously described in connection with FIGS. 6 and 7. The structures of the soft member 20B and the tapered barrel 10C with the stud bolt 12B, and the state in which the tapered barrel 10C is embedded in the soft member 20B are similar to those previously described in connection with FIGS. 8 and 9.

As described above, according to this embodiment, the tapered barrels are embedded in the soft members for fastening the soft members together with a bolt, and the height of the tapered portion of the tapered hole is made substantially equal to the length of the tapered portion of the tapered barrel, thereby making it possible to firmly couple the soft members together, and to protect the soft members from cracking and so on.

Since the tapered barrels are formed of a material harder than the soft members, the two hard tapered barrels surrounding the bolt in internal contact with each other support the fastening force exerted by the bolt, so that the soft members can be protected from crushing, cracking and so on.

Further, even if the soft members have small thicknesses, they can be firmly fastened with the aid of the tapered barrels.

Some coupling structures and methods of a soft member and a metal member according to the present invention will be described with reference to FIGS. 11 through 13.

Referring first to FIG. 11, description will be made on a first coupling structure and method of a soft member and a metal member according to an embodiment.

FIG. 11 is a partial cross-sectional view illustrating the first structure in which a soft member and a metal member are coupled together in accordance with this embodiment. The same reference numerals as those in FIGS. 1 through 10 designate the same parts.

A metal member 20D has been previously formed with a throughhole 24 by machining or the like. A tapered barrel 10B with a female thread has been previously embedded in a soft member 20B made of plastic or the like. The tapered barrel 10B is formed of a material harder than the soft member 20B such as stainless steel, iron, brass, aluminum, hard resin or the like. Among these materials, stainless steel, iron and brass, which are relatively hard materials, are suitable for protecting the soft member 20B from crushing and fracture when the soft member 20B is fastened to the metal member 20D with a bolt. The structures of the soft member 20B and the tapered barrel 10B with the female thread, and the state in which the tapered barrel 10B is embedded in the soft member 20B are similar to those previously described in connection with FIGS. 2, 3B and 4B.

The metal member 20D is placed on the soft member 20B having the tapered barrel 10B embedded therein, and a bolt 30 is inserted through the central throughhole 24 of the metal member 20D so that a male thread formed on the bolt 30 is engaged with the female thread of the tapered barrel 10B, thereby coupling the metal member 20D and the soft member 20B together.

Alternatively, as illustrated in FIG. 8, the metal member 20D may be coupled to a soft member embedded with the tapered barrel 10C with a stud bolt using a nut 40, instead of the tapered barrel 10B with the female thread and the bolt 30.

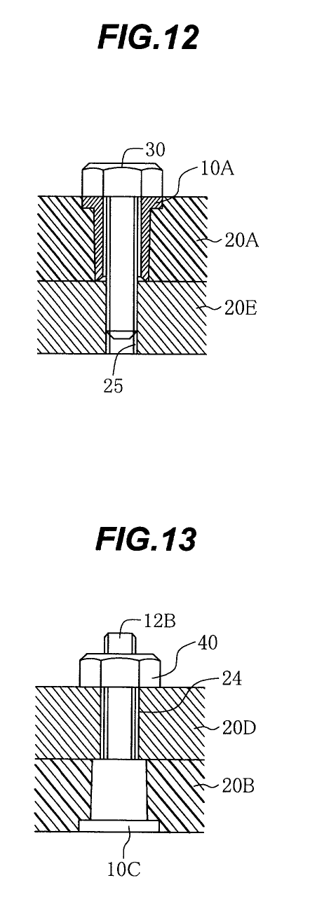

Referring next to FIG. 12, description will be made on a second coupling structure and method of a soft member and a metal member according to an embodiment.

FIG. 12 is a partial cross-sectional view illustrating the second coupling structure in which a soft member and a metal member are coupled together in accordance with this embodiment. The same reference numerals as those in FIGS. 1 through 11 designate the same parts.

A tapered barrel 10A has been previously embedded in a soft member 20A made of plastic or the like. The tapered barrel 10A is formed of a material harder than the soft member 20A such as stainless steel, iron, brass, aluminum, hard resin or the like. Among these materials, stainless steel, iron and brass, which are relatively hard materials, are suitable for protecting the soft member 20A from crushing and fracture when the soft member 20A and a metal member 20E are coupled together with a bolt.

The metal member 20E has been previously formed with a female thread 25 by thread cutting or the like. The structures of the soft member 20A and the tapered barrel 10A with a female thread, and the state in which the tapered barrel 10A is embedded in the soft member 20A are similar to those previously described in connection with FIGS. 2, 3A and 4A.

The metal member 20E is placed on the soft member 20A having the tapered barrel 10A embedded therein, and a bolt 30 is inserted through a central throughhole 24 of the metal member 20E so that a male thread formed on the bolt 30 is engaged with the female thread 25 of the metal member 20E, thereby coupling the metal member 20E and the soft member 20A together.

Referring next to FIG. 13, description will be made on a third coupling structure and method of a soft member and a metal member according to an embodiment. The same reference numerals as those in FIGS. 1 through 12 designate the same parts.

FIG. 13 is a partial cross-sectional view illustrating the third structure in which a soft member and a metal member are coupled together in accordance with this embodiment.

A metal member 20D has been previously formed with a throughhole 24 by machining or the like. On the other hand, a tapered barrel 10C with a stud bolt has been previously embedded in a soft member 20B made of plastic or the like. The structures of the soft member 20B and the tapered barrel 10C with a stud bolt, and the state in which the tapered barrel 10C is embedded in the soft member 20B are similar to those previously described in connection with FIG. 8.

The metal member 20D is placed on the soft member 20B having the tapered barrel 10B with a stud bolt 12B embedded therein, and the stud bolt 12B is inserted through the throughhole 24 of the metal member 20D and screwed into a nut 40, thereby coupling the metal member 20D and the soft member 20B together.

As described above, according to the foregoing embodiments, since the tapered barrel 10A, 10B or 10C embedded in the associated soft member comes in contact with the metal surface for coupling the soft member and the metal member together, a fastening force exerted by the bolt or the like acts on the tapered barrel 10A, 10B or 10C even when the metal member is fastened to the soft member made of a resin material or the like, thereby making it possible to protect the soft member from cracking (creep) and so on.

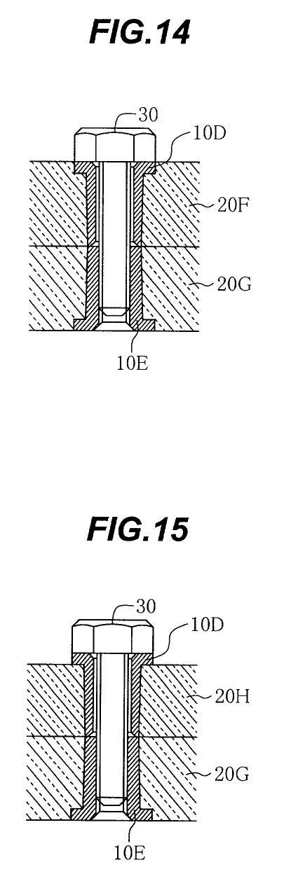

Next, some coupling structures and methods of two brittle members according to the present invention will be described with reference to FIGS. 14 through 16.

Referring first to FIG. 14, description will be made on a first coupling structure and method of two brittle members according to an embodiment.

FIG. 14 is a partial cross-sectional view illustrating the first structure in which two brittle members are coupled together in accordance with this embodiment. The same reference numerals as those in FIGS. 1 through 13 designate the same parts.

A tapered barrel 10D with a throughhole has been previously embedded in a brittle member 20F made of cement, ceramics, stone material, glass or the like. On the other hand, a tapered barrel 10E with a female thread has been previously embedded in a brittle member 20G made of cement, ceramics, stone material, glass or the like. The tapered barrels 10D, 10E are formed of a material softer than the brittle members 20F, 20G such as stainless steel, iron, brass, aluminum, hard resin or the like. Among these materials, aluminum, hard resin and so on, which are relatively soft materials, are particularly suitable for protecting the brittle members 20F, 20G from cracking when they are fastened together with a bolt. The structures of the tapered barrels 10D, 10E are as previously illustrated in FIG. 3. The structures of the brittle members 20F, 20G are similar to those of the soft members 20A, 20B illustrated in FIG. 2.

The brittle member 20F having the tapered barrels 10D embedded therein is placed on the brittle member 20G having the tapered barrel 10E embedded therein, and a bolt 30 is inserted through the central throughhole of the tapered barrel 10D so that a male thread formed on the bolt 30 is engaged with the female thread of the tapered barrel 10E, thereby coupling the brittle members 20F, 20G together.

As described above, since the coupling structure comprises the tapered barrels 10D, 10E, which are softer than the brittle members 20F, 20G, disposed around the bolt, a fastening force exerted by the bolt or the like acts on the embedded tapered barrels 10D, 10E and is absorbed by the relatively soft tapered barrels 10D, 10E, even when the brittle members are fastened together, thereby making it possible to protect the brittle members 20F, 20G from cracking (creep) and so on.

Referring next to FIG. 15, description will be made on a second coupling structure method of two brittle members according to an embodiment.

FIG. 15 is a partial cross-sectional view illustrating the second structure in which two brittle members are coupled together in accordance with this embodiment. The same reference numerals as those in FIGS. 1 through 14 designate the same parts.

A tapered barrel 10D with a throughhole has been previously embedded in a brittle member 20H. On the other hand, a tapered barrel 10E with a female thread has been previously embedded in a brittle member 20G. The structures of the tapered barrels 10D, 10E are as previously illustrated in FIG. 3. Also, the structure of the brittle member 20G is similar to that previously described in connection with FIG. 14. Further, the structure of the brittle member 20H is similar to the soft member 20C illustrated in FIG. 5. The brittle member 20H having the tapered barrel 10D embedded therein is placed on the brittle member 20G having the tapered barrel 10E embedded therein, and a bolt 30 is inserted through the central throughhole of the tapered barrel 10D so that a male thread formed on the bolt 30 is engaged with the female thread of the tapered barrel 10E, thereby coupling the brittle members 20H, 20G together.

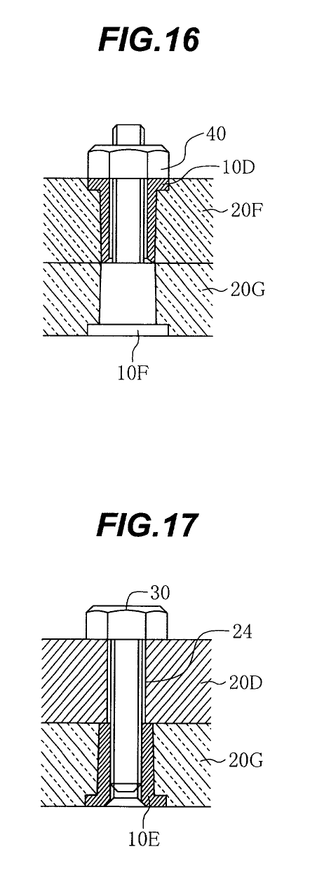

Referring next to FIG. 16, description will be made on a third coupling structure and method of two brittle members according to an embodiment.

FIG. 16 is a partial cross-sectional view illustrating the third structure in which two brittle members are coupled together in accordance with this embodiment. The same reference numerals as those in FIGS. 1 through 15 designate the same parts.

A tapered barrel 10D with a throughhole has been previously embedded in a brittle member 20F, in a manner similar to that illustrated in FIG. 14. On the other hand, a tapered barrel 10F with a stud bolt 12B has been previously embedded in a brittle member 20G. The structure of the brittle member 20G is similar to the soft member 20C illustrated in FIG. 8. The brittle member 20F having the tapered barrel 10D embedded therein is placed on the brittle member 20G having the tapered barrel 10F embedded therein, and the stud bolt 12B of the tapered barrel 10F is inserted through the central throughhole of the tapered barrel 10D and screwed into a nut 40, thereby coupling the brittle members 20F, 20G together.

As described above, according to the foregoing embodiments, since the tapered barrels 10D, 10F are formed of a material softer than the brittle members, and the soft tapered barrels 10D, 10F surrounding the bolt come in internal contact with each other when the brittle members are fastened together, a fastening force exerted by the bolt or the like acts on the tapered barrels 10D, 10F, thereby making it possible to protect the brittle members 20F, 20G from cracking (creep) and so on.

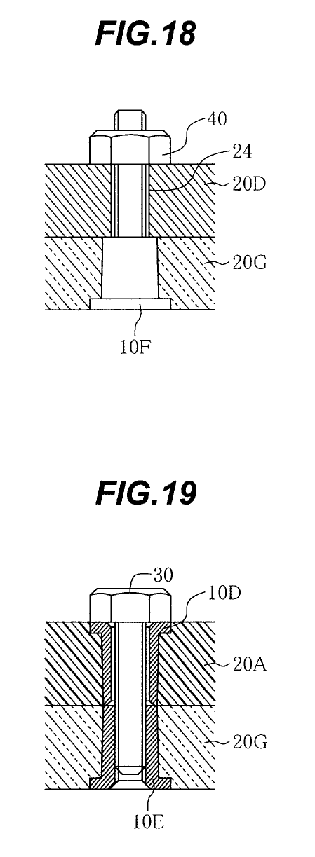

Next, a coupling structure and method of a brittle member and a metal member according to the present invention, will be described with reference to FIGS. 17 and 18.

Referring first to FIG. 17, description will be made on a first coupling structure of a brittle member and a metal member according to an embodiment.

FIG. 17 is a partial cross-sectional view illustrating the first structure in which a brittle member and a metal member are coupled together in accordance with this embodiment. The same reference numerals as those in FIGS. 1 through 16 designate the same parts.

A metal member 20D has been previously formed with a throughhole 24 by machining or the like. On the other hand, a tapered barrel 10E with a female thread has been previously embedded in a brittle member 20G. The structures of the brittle member 20G and the tapered barrel 10E with the female thread, and the state in which the tapered barrel 10E is embedded in the brittle member 20G are similar to those previously described in connection with FIG. 14.

The metal member 20D is placed on the brittle member 20G having the tapered barrel 10E embedded therein, and a bolt 30 is inserted through the central throughhole 24 of the metal member 20D so that a male thread formed on the bolt 30 is engaged with the female thread of the tapered barrel 10E, thereby coupling the metal member 20D and the brittle member 20G together.

Alternatively, as illustrated in FIG. 8, the metal member 20D may be coupled to a brittle member embedded with the tapered barrel 10F with a stud bolt using a nut 40, instead of the tapered barrel 10E with the female thread and the bolt 30.

Referring next to FIG. 18, description will be made on a second coupling structure and method of a brittle member and a metal member according to an embodiment.

FIG. 18 is a partial cross-sectional view illustrating the second structure in which a brittle member and a metal member are coupled together in accordance with this embodiment. The same reference numerals as those in FIGS. 1 through 17 designate the same parts.

The metal member 20D has been previously formed with a throughhole 24 by machining or the like. On the other hand, a tapered barrel 10F with a stud bolt 12B has been previously embedded in a brittle member 20G, as previously described in connection with FIG. 16.

The metal member 20E is placed on the brittle member 20G having the tapered barrel 10E with the stud bolt 12B embedded therein, and the stud bolt 12B of the tapered barrel 10F is inserted through the throughhole 24 of the metal member 20D and screwed into a nut 40, thereby coupling the metal member 20D and the brittle member 20G together.

Thus, according to the foregoing embodiments, the foregoing coupling structure causes a fastening force exerted by the bolt or the like to act on the tapered barrel 10F made of a softer material and surrounding the bolt, when the metal member and the brittle member are fastened together, thereby making it possible to protect the brittle member from cracking (creep) and so on.

Next, a coupling structure and method of a brittle member and a soft member according to the present invention will be described with reference to FIG. 19.

FIG. 19 is a partial cross-sectional view illustrating the coupling structure in which a brittle member and a soft member are coupled together in accordance with an embodiment. The same reference numerals as those in FIGS. 1 through 18 designate the same parts.

A tapered barrel 10D with a throughhole has been previously embedded in a soft member 20A in a manner similar to that illustrated in FIG. 1. On the other hand, a tapered barrel 10E with a female thread has been previously embedded in a brittle member 20G in a manner similar to that illustrated in FIG. 14. The soft member 20A embedded with the tapered barrel 10D is placed on the brittle member 20G embedded with the tapered barrel 10E, and a bolt 30 is inserted through the central throughhole of the tapered barrel 10D so that a male thread formed on the bolt 30 is engaged with the female thread of the tapered barrel 10E, thereby coupling the soft member 20A and the brittle member 20G together.

Since such a coupling structure causes a fastening force exerted by the bolt or the like to act on the tapered barrels 10D, 10E, even when the soft member 20A and the brittle member 20G are fastened together, it is possible to protect the soft member 20A from cracking. Also, since the fastening force is absorbed by the relatively soft tapered barrel 10E, the brittle member 20G can be protected from cracking (creep) and so on.

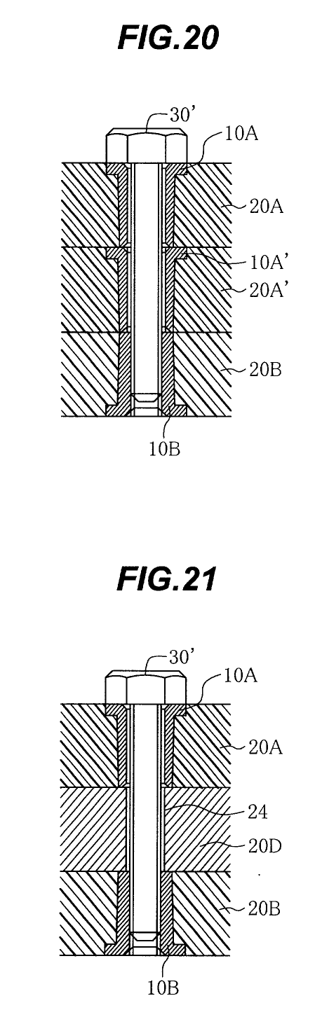

Next, a coupling structure and method of three members according to the present invention will be described with reference to FIGS. 20 through 22.

Referring first to FIG. 20, description will be made on a coupling structure and method of three soft members according to an embodiment.

FIG. 20 is a partial cross-sectional view illustrating a coupling structure in which three soft members are coupled together according to this embodiment. The same reference numerals as those in FIGS. 1 through 19 designate the same parts.

Tapered barrels 10A, 10A′ each with a throughhole have been previously embedded in soft members 20A, 20A′ made of plastic or the like, respectively, in a manner similar to that illustrated in FIG. 1. On the other hand, a tapered barrel 10B with a female thread has been previously embedded in a soft member 20B made of plastic or the like in a manner similar to that illustrated in FIG. 1. The tapered barrels 10A, 10A′, 10B are formed of a material harder than the soft members 20A, 20A′, 20B such as stainless steel, iron, brass, aluminum, hard resin or the like.

The soft members 20A, 20A′, 20B respectively having the tapered barrels 10A, 10A′, 10B embedded therein are stacked in this order, and a bolt 30′ is inserted through the central throughholes of the tapered barrels 10A, 10A′ so that a male thread formed on the bolt 30′ is engaged with the female thread of the tapered barrel 10B, thereby coupling the soft members 20A, 20A′, 20B together.

Since such a coupling structure causes a fastening force exerted by the bolt or the like to act on the tapered barrels 10A, 10A′, 10B, even when the soft members 20A, 20A′, 20B made of a resin material or the like are fastened together, the soft members 20A, 20A′, 20B can be protected from cracking (creep) and so on. Instead of the soft members 20A, 20A′, 20B, the foregoing coupling structure may be applied likewise to coupling of three brittle members, in which case the tapered barrels 10D, 10E are used instead of the tapered barrels 10A, 10B.

Referring next to FIG. 21, description will be made on a first coupling structure and method of coupling two soft members and a metal member according to an embodiment.

FIG. 21 is a partial cross-sectional view illustrating the first coupling structure in which two soft members and a metal member are coupled together in accordance with this embodiment. The same reference numerals as those in FIGS. 1 through 20 designate the same parts.

A tapered barrel 10A with a throughhole has been previously embedded in a soft member 20A made of plastic or the like in a manner similar to that illustrated in FIG. 1. On the other hand, a metal member 20D has been previously formed with a throughhole 24 in a manner similar to that illustrated in FIG. 11. Further, a tapered barrel 10B with a female thread has been previously embedded in a soft member 20B made of plastic or the like in a manner similar to that illustrated in FIG. 1. The tapered barrels 10A, 10B are formed of a material harder than the soft members 20A, 20B such as stainless steel, iron, brass, aluminum, hard resin or the like.

The soft member 20A having the tapered barrel 10A embedded therein is put on the metal member 20D which is put on the soft member 20B having the tapered barrel 10B embedded therein, and a bolt 30′ is inserted through the central throughhole of the tapered barrel 10A and the throughhole 24 so that a male thread formed on the bolt 30′ is engaged with the female thread of the tapered barrel 10B, thereby coupling the soft members 20A, 20B and the metal member 20D together.

Since such a structure causes a fastening force exerted by the bolt or the like to act on the tapered barrels 10A, 10B even when the two soft members 20A, 20B and the metal member 20D are fastened together, the soft members 20A, 20B can be protected from cracking (creep) and so on. Instead of the soft members 20A, 20B, the foregoing structure may be applied likewise to coupling of two brittle members and a metal member, in which case the tapered barrels 10D, 10E are used instead of the tapered barrels 10A, 10B.

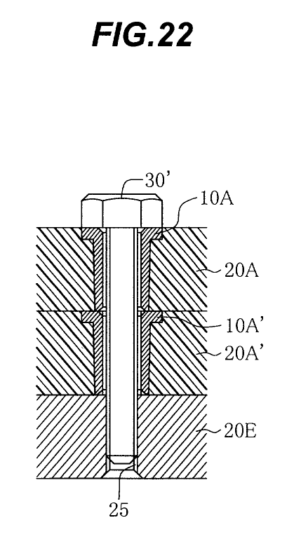

Referring next to FIG. 22, description will be made on a second coupling structure and method of two soft members according to an embodiment.

FIG. 22 is a partial cross-sectional view illustrating the second coupling structure in which two soft members and a metal member are coupled together in accordance with this embodiment. The same reference numerals as those in FIGS. 1 through 21 designate the same parts.

Tapered barrels 10A, 10A′ each with a throughhole have been previously embedded in soft members 20A, 20A′ made of plastic or the like, respectively, in a manner similar to that illustrated in FIG. 1. On the other hand, a metal member 20E has been previously formed with a female thread 25 in a manner similar to that illustrated in FIG. 12. The tapered barrels 10A, 10A′ are formed of a material harder than the soft members 20A, 20A′ such as stainless steel, iron, brass, aluminum, hard resin or the like.

As illustrated, the soft members 20A, 20A′ having the tapered barrels 10A, 10A′ embedded therein and the metal member 20E are stacked in this order, and a bolt 30′ is inserted through the central throughholes of the tapered barrels 10A, 10A′ so that a male thread formed on the bolt 30′ is engaged with the female thread 25, thereby coupling the soft members 20A, 20A′ and the metal member 20E together.

Since such a coupling structure causes a fastening force exerted by the bolt or the like to act on the tapered barrels 10A, 10A′ even when the two soft members 20A, 20A′ and the metal member 20E are fastened together, the soft members 20A, 20A′ can be protected from cracking (creep) and so on. Instead of the soft members 20A, 20A′, the foregoing structure may be applied likewise to coupling of two brittle members and a metal member, in which case the tapered barrels 10D are used instead of the tapered barrels 10A, 10A′.

According to the present invention, even when a brittle member or a soft member is coupled to a member made of a different material, they can be protected from cracking and so on.

What is claimed is:

1. A structure of bonding parts comprising:
a first member formed with a first hole having a tapered portion;
a second member formed with a second hole; and
a first tapered barrel embedded in said first hole, said first tapered barrel having a tapered portion,
wherein said first and second members are fastened with a bolt inserted through said first and second holes arranged in alignment with each other, and
the tapered portion of said first hole has a height substantially equal to a length of the tapered portion of said first tapered barrel.

2. A structure of bonding parts according to claim 1, wherein:
said first member is a soft member; and
said first tapered barrel is formed of a material harder than said first member.

3. A structure of bonding parts according to claim 1, wherein:
said first member is a brittle member; and
said first tapered barrel is formed of a material softer than said first member.

4. A structure of bonding parts according to claim 1, wherein:
said second hole is formed with a tapered portion; and
said coupling structure further comprises a second tapered barrel embedded in said second hole, said second tapered barrel having a tapered portion.

5. A structure of bonding parts according to claim 4, wherein:
said first tapered barrel has a female thread;
said second tapered barrel has a throughhole; and
said first and second members are fastened together by a bolt inserted through said through hole and screwed into said female thread.

6. A structure of bonding parts according to claim 4, wherein:
said first tapered barrel has a stud bolt;
said second tapered barrel has a throughhole; and
said first and second members are fastened together by the stud bolt inserted through said throughhole and screwed into a nut.

7. A structure of bonding parts according to claim 4, wherein:
the tapered portion of said second hole has a height substantially equal to a length of the tapered portion of said second tapered barrel.

8. A structure of bonding parts according to claim 1, wherein:
said first tapered barrel has a female thread;
said second hole is a throughhole; and
said first and second members are fastened together by a bolt inserted through said throughhole and screwed into said female thread.

9. A structure of bonding parts according to claim 1, wherein:
said first tapered barrel has a throughhole;
said second hole is formed with a female thread; and
said first and second members are fastened together by a bolt inserted through said throughhole and screwed into said female thread.

10. A method of bonding parts comprising the steps of:
forming a first member with a first hole having a tapered portion;
embedding a first tapered barrel having a tapered portion into said first hole;
forming a second member with a hole extending there through;
arranging said first and second members such that said first hole is in alignment with said second hole; and
fastening said first and second members together by inserting a bolt through said first second holes,
wherein the tapered portion of said first hole has a height substantially equal to a length of the tapered portion of said first tapered barrel.

11. A method of bonding parts according to claim 10, wherein:
said first member and said second member are coupled by said first tapered barrel formed of a material harder than said first member.

12. A method of bonding parts according to claim 10, wherein:
said first member and said second member are coupled by said first tapered barrel formed of a material softer than said first member.

13. A structure of bonding parts comprising:
a first member having an inner surface in a first tapered shape;
a first barrel formed of a material harder than said first member and having a second tapered shape which matches said first tapered shape;
a second member having an inner surface defining a first hole opposite to said first barrel, and a surface surrounding said inner surface in internal contact with said first barrel formed of a material harder than said first member;
a male thread inserted into said first hole; and
a female thread engaged with said male thread.

14. A structure of bonding parts according to claim 13, further comprising:
a second barrel made of a material harder than said second member, and having an outer surface in a third tapered shape and said female thread formed on an inner surface thereof,
wherein said first hole has a surface in a fourth tapered shape which matches said second barrel; and
said second barrel has a contact face at one end thereof.

15. A structure of bonding parts according to claim 13, wherein:
said second member is harder than said first member.

16. A structure of bonding parts comprising:
a first member having an inner surface in a first tapered shape;
a first barrel formed of a material softer than said first member and having a second tapered shape which matches said first tapered shape;
a second member having an inner surface defining a first hole opposite to said first barrel, and a surface surrounding said inner surface in internal contact with said first barrel formed of a material softer than said first member;
a male thread inserted into said first hole; and
a female thread engaged with said male thread.

17. A structure of bonding parts according to claim 16, further comprising:
a second barrel formed of a material softer than said second member, and having an outer surface formed in a third tapered shape and said female thread formed on an inner surface, said first hole having a surface in a fourth tapered shape which matches said second barrel,
wherein said second barrel has a contact face at one end thereof.

18. A structure of bonding parts according to claim 16, wherein:
said second member is more brittle than said first member.

19. A method of coupling a first member and a second member together, comprising the steps of:
fitting a first barrel having a second tapered shape into an inner surface of said first member formed in a first tapered shape, said first barrel being harder than said first member;
positioning said second member having a peripheral surface formed of a material harder than said first member around a screw insertion hole, and said first member such that said first barrel opposes said screw insertion hole;
inserting a screw into said screw insertion hole; and
fastening said screw such that said first tapered barrel comes in internal contact with said peripheral surface to couple said first member and said second member together.

20. A method of coupling a first member and a second member together, comprising the steps of:
fitting a first barrel having a second tapered shape into an inner surface of said first member formed in a first tapered shape, said first barrel being softer than said first member;
positioning said second member having a peripheral surface formed of a material softer than said first member around a screw insertion hole, and said first member such that said first barrel opposes said screw insertion hole;
inserting a screw into said screw insertion hole; and
fastening said screw such that said first tapered barrel comes in internal contact with said peripheral surface to couple said first member and said second member together.
